(19) United States
(12) Patent Application Publication
(10) Pub. No.: US 2011/0319099 A1
(43) Pub. Date: Dec. 29, 2011

(54) NAVIGATION OR MAPPING SYSTEM AND METHOD

(76) Inventor: Leonardus Gerardus Maria Beuk, Veldhoven (NL)

(21) Appl. No.: 13/144,504

(22) PCT Filed: Jan. 14, 2009
(86) PCT No.: PCT/EP09/50371

§ 371 Date: Sep. 20, 2011

(51) Int. Cl. H04W 24/00

(52) U.S. Cl. 455/456.3

(57) ABSTRACT

A navigation or mapping system comprises a display device (240) and a processing resource (210, 490) arranged to process map data, traffic data and location data representative of the location of a vehicle, to produce an output representative of a traffic animation sequence, wherein the traffic animation sequence comprises a traffic indicator (530) on a map, the traffic indicator (530) is representative of traffic and the traffic indicator (530) varies to represent the variation of traffic between a start time and an end time, the processing resource is configured to vary at least one feature of the animation sequence in dependence upon the variation of the location of the vehicle between the start time and the end time, and the display device is responsive to the output from the processing resource to display the traffic animation sequence.

### FIELD OF THE INVENTION

The present invention relates to a navigation or mapping system and method and in particular to a navigation or mapping system and method that is able to provide an indication of traffic conditions to a user.

### BACKGROUND TO THE INVENTION

Portable navigation devices (PNDs) that include GPS (Global Positioning System) signal reception and processing functionality are well known and are widely employed as in-car or other vehicle navigation systems.

In general terms, a modern PNDs comprises a processor, memory (at least one of volatile and non-volatile, and commonly both), and map data stored within said memory. The processor and memory cooperate to provide an execution environment in which a software operating system may be established, and additionally it is commonplace for one or more additional software programs to be provided to enable the functionality of the PND to be controlled, and to provide various other functions.

Typically these devices further comprise one or more input interfaces that allow a user to interact with and control the device, and one or more output interfaces by means of which information may be relayed to the user. Illustrative examples of output interfaces include a visual display and a speaker for audible output. Illustrative examples of input interfaces include one or more physical buttons to control on/off operation or other features of the device (which buttons need not necessarily be on the device itself but could be on a steering wheel if the device is built into a vehicle), and a microphone for detecting user speech. In one arrangement the output interface display may be configured as a touch sensitive display (by means of a touch sensitive overlay or otherwise) to additionally provide an input interface by means of which a user can operate the device by touch.

Devices of this type will also often include one or more physical connector interfaces by means of which power and optionally data signals can be transmitted to and received from the device, and optionally one or more wireless transmitters/receivers to allow communication over cellular telecommunications and other signal and data networks, for example Wi-Fi, Wi-Max GSM and the like.

PND devices of this type also include a GPS antenna by means of which satellite-broadcast signals, including location data, can be received and subsequently processed to determine a current location of the device.

The PND device may also include electronic gyroscopes and accelerometers which produce signals that can be processed to determine the current angular and linear acceleration, and in turn, and in conjunction with location information derived from the GPS signal, velocity and relative displacement of the device and thus the vehicle in which it is mounted. Typically such features are most commonly provided in in-vehicle navigation systems, but may also be provided in PND devices if it is expedient to do so.

The utility of such PNDs is manifested primarily in their ability to determine a route between a first location (typically a start or current location) and a second location (typically a destination). These locations can be input by a user of the device, by any of a wide variety of different methods, for example by postcode, street name and house number, previously stored “well known” destinations (such as famous locations, municipal locations (such as sports grounds or swimming baths) or other points of interest), and favourite or recently visited destinations.

Typically, the PND is enabled by software for computing a “best” or “optimum” route between the start and destination address locations from the map data. A “best” or “optimum” route is determined on the basis of predetermined criteria and need not necessarily be the fastest or shortest route. The selection of the route along which to guide the driver can be very sophisticated, and the selected route may take into account existing, predicted and dynamically and/or wirelessly received traffic and road information, historical information about road speeds, and the drivers own preferences for the factors determining road choice (for example the driver may specify that the route should not include motorways or toll roads).

In addition, the device may continually monitor road and traffic conditions, and offer to or choose to change the route over which the remainder of the journey is to be made due to changed conditions. Real time traffic monitoring systems, based on various technologies (e.g. mobile phone data exchanges, fixed cameras, GPS fleet tracking) are being used to identify traffic delays and to feed the information into notification systems.

PNDs of this type may typically be mounted on the dashboard or windscreen of a vehicle, but may also be formed as part of an on-board computer of the vehicle radio or indeed as part of the control system of the vehicle itself. The navigation device may also be part of a hand-held system, such as a PDA (Portable Digital Assistant) a media player, a mobile phone or the like, and in these cases, the normal functionality of the hand-held system is extended by means of the installation of software on the device to perform both route calculation and navigation along a calculated route.

Route planning and navigation functionality may also be provided by a desktop or mobile computing resource running appropriate software. For example, the Royal Automobile Club (RAC) provides an on-line route planning and navigation facility at http://www.rac.co.uk, which facility allows a user to enter a start point and a destination whereupon the server to which the user's PC is connected calculates a route (aspects of which may be user specified), generates a map, and generates a set of exhaustive navigation instructions for guiding the user from the selected start point to the selected destination. The facility also provides for pseudo three-dimensional rendering of a calculated route, and route preview functionality which simulates a user travelling along the route and thereby provides the user with a preview of the calculated route.

In the context of a PND, once a route has been calculated, the user interacts with the navigation device to select the desired calculated route, optionally from a list of proposed routes. Optionally, the user may intervene in, or guide the route selection process, for example by specifying that certain routes, roads, locations or criteria are to be avoided or are mandatory for a particular journey. The route calculation aspect of the PND forms one primary function, and navigation along such a route is another primary function.

During navigation along a calculated route, it is usual for such PNDs to provide visual and/or audible instructions to guide the user along a chosen route to the end of that route, i.e. the desired destination. It is also usual for PNDs to display map information on-screen during the navigation, such information regularly being updated on-screen so that the map information displayed is representative of the current location of the device, and thus of the user or user's vehicle if the device is being used for in-vehicle navigation.

An icon displayed on-screen typically denotes the current device location, and is centred with the map information of current and surrounding roads in the vicinity of the current device location and other map features also being displayed. Additionally, navigation information may be displayed, optionally in a status bar above, below or to one side of the displayed map information, examples of navigation information include a distance to the next deviation from the current road required to be taken by the user, the nature of that deviation possibly being represented by a further icon suggestive of the particular type of deviation, for example a left or right turn. The navigation function also determines the content, duration and timing of audible instructions by means of which the user can be guided along the route. As can be appreciated a simple instruction such as “turn left in 100 m” requires significant processing and analysis. As previously mentioned, user interaction with the device may be by a touch screen, or additionally or alternately by steering column mounted remote control, by voice activation or by any other suitable method.

A further important function provided by the device is automatic route re-calculation in the event that: a user deviates from the previously calculated route during navigation (either by accident or intentionally); real-time traffic conditions dictate that an alternative route would be more expedient and the device is suitably enabled to recognize such conditions automatically, or if a user actively causes the device to perform route re-calculation for any reason.

It is also known to allow a route to be calculated with user defined criteria; for example, the user may prefer a scenic route to be calculated by the device, or may wish to avoid any roads on which traffic congestion is likely, expected or currently prevailing. The device software would then calculate various routes and weigh more favourably those that include along their route the highest number of points of interest (known as POIs) tagged as being for example of scenic beauty, or, using stored information indicative of prevailing traffic conditions on particular roads, order the calculated routes in terms of a level of likely congestion or delay on account thereof. Other POI-based and traffic information-based route calculation and navigation criteria are also possible.

Although the route calculation and navigation functions are fundamental to the overall utility of PNDs, it is possible to use the device purely for information display, or “free-driving”, in which only map information relevant to the current device location is displayed, and in which no route has been calculated and no navigation is currently being performed by the device. Such a mode of operation is often applicable when the user already knows the route along which it is desired to travel and does not require navigation assistance.

Devices of the type described above, for example the 720T model manufactured and supplied by TomTom International B.V., provide a reliable means for enabling users to navigate from one position to another.

Whilst up-to-date traffic information may be used in planning routes or estimating times or speeds of travel by navigation devices of the type described above, and whilst such information is also available via publicly-accessible websites, known systems do not provide an intuitive or efficient way for users to access such information. Furthermore, known systems do not provide an intuitive or efficient way for users to determine changes in traffic conditions over time.

Some traffic websites provide maps that show traffic information, but such traffic information usually only represents the latest information, and provides only a static snapshot of traffic conditions. The user can determine the static traffic situation but not the tendency or variation of the traffic situation with time, for example how or whether the length of a traffic jam is increasing or decreasing, whether the location of a traffic jam is moving, or whether the average speed is increasing or decreasing.

The traffic website www.anwb.nl displays an icon, in the form of a triangle, on a map to represent a traffic jam, and colours the icon green if the traffic jam has decreased in size recently or red if the traffic jam has increased in size recently. However, the website provides only a static view, and the user is not able to determine the extent to which the traffic jam has increased or decreased in size, or to determine any movement of the location of the traffic jam or speed of movement of vehicles.

### SUMMARY OF THE INVENTION

According to a first aspect of the present invention, there is provided a navigation or mapping system comprising:—a display device; and a processing resource arranged to process map data, traffic data and location data representative of the location of a vehicle, and to produce an output representative of a traffic animation sequence, wherein the traffic animation sequence comprises a traffic indicator on a map, the traffic indicator is representative of traffic and the traffic indicator varies to represent the variation of traffic between a start time and an end time, the processing resource is configured to vary at least one feature of the animation sequence in dependence upon the variation of the location of the vehicle between the start time and the end time, and the display device is responsive to the output from the processing resource to display the traffic animation sequence.

The traffic indicator may be representative of traffic flow at the location. Traffic flow at a location may comprise the average speed of travel of vehicles at the location and/or the throughput of vehicles at the location and/or the presence or absence of a traffic jam at the location. The varying of the traffic indicator may comprise varying the appearance of the traffic indicator, and may comprise varying the position and/or size of the traffic indicator.

The output may comprise display data suitable for processing by the or a display device to display the traffic animation sequence.

The or each location of the vehicle may comprise a measured location and/or a predicted location or other potential location.

The system may comprise a location determining unit for determining the location of the vehicle, and for providing the location data representative of the location of the vehicle. The location determining unit may be permanently installed or for permanent installation in the vehicle, or may be for temporary installation and removal from the vehicle by a user.

The location determining unit may provide location data representative of the determined location. The system may further comprise a memory for storing the location data and/or the map data and/or the traffic data.

The duration of the traffic animation sequence may be shorter than the difference between the start time and the end time. Thus the traffic animation sequence may be a non-real time animation sequence.

The difference between the start time and the end time may be at least one of 10 times, 100 times, or 1000 times greater than the duration of the traffic animation sequence.

The variation of the at least one feature of the animation sequence may comprise varying the area represented by the map and/or a relative position or orientation of the map.

The traffic animation sequence may comprise a vehicle indicator representative of the location of the vehicle, and the variation of the at least one feature of the animation sequences comprises varying the position of the vehicle indicator on the map to represent the variation of the location of the vehicle between the start time and the end time.

The traffic animation sequence may further comprise a further vehicle indicator representative of an expected location of the vehicle. The position of the further vehicle indicator may vary to represent the variation of the expected location of the vehicle between the start time and the end time. The expected location of the vehicle may be a location expected for the vehicle if the vehicle had travelled along a predetermined route at an expected speed.

The traffic animation sequence may comprise a plurality of vehicle indicators, each representative of the location of a respective vehicle.

The traffic animation sequence may comprise the display of each of a series of views during a respective display time, and for each view the traffic indicator is representative of the traffic at the location at a respective, different traffic determination time. Each view may be a static view. For each view, the position of the vehicle indicator may be representative of the location of the vehicle at the corresponding traffic determination time.

The time difference between a first traffic determination time, for which the traffic is represented by a view in the series, and a second traffic determination time, for which the traffic is represented by the next view in the series, may be substantially equal to a predetermined step time or a multiple of the predetermined step time. The multiple of the predetermined step time may an integer multiple of the predetermined step time.

The step time may be greater than the display time. The step time may be at least one of 10 times, 100 times or 1000 times greater than the or each display time.

The traffic animation sequence may further comprise a time indicator representative of the traffic determination time for each view of the animation sequence, and the time indicator varies to represent the variation of traffic determination time during the animation sequence.

Varying the time indicator may comprise varying the appearance of the time indicator and/or varying the value of at least one displayed numeral representative of the time for which the traffic is represented.

The time indicator may comprise a time indicator area and a moveable marker, and the position of the marker relative to the time indicator area is representative of the traffic determination time of the displayed view. Thus, the position of the time marker relative to the time indicator area may vary during the animation sequence. The position of the marker relative to the time indicator area may be a position relative to the time indicator area in a predetermined direction.

The position of the or a moveable marker relative to the or a time indicator area may be representative of the speed of the animation sequence. The speed of the animation sequence may be the ratio of the duration of the animation sequence to the difference between the start time and the end time.

The moveable marker may be moveable in response to user input, and movement of the moveable marker may change the view in the series that is displayed or the speed of the animation sequence.

At least one of the start time and the end time may be a future time. The estimation of traffic flow at a location at a time in the future may comprise extrapolating from current traffic flow and/or traffic flows at times in the past, and/or estimating the traffic flow in dependence upon historical traffic flow data and/or traffic flow data for other locations. The estimation of vehicle location at a time in the future may comprise extrapolating from current vehicle location and/or vehicle locations at times in the past, and/or estimating the vehicle location in dependence upon traffic flow data.

The output may represents at least one display feature that varies in dependence upon whether the time for which the traffic is represented is in the past or in the future.

The varying of the traffic indicator may comprise varying at least one of the colour, size and shape or associated text of the traffic indicator. Alternatively or additionally, the varying of traffic indicator may comprise making the traffic indicator appear or disappear.

The traffic indicator may be representative of a traffic queue at the location. The traffic queue may be a queue of stationary traffic, or traffic moving at a speed below a predetermined threshold (for example 5 miles per hour or 10 miles per hour).

The variation of the traffic indicator may be representative of a variation in the length of the traffic queue and/or a variation in the rate of change of the length of the traffic queue.

The traffic indicator or each part of the traffic indicator may be overlaid on the map in one-to-one correspondence with the area of the map that is representative of the location represented by the traffic indicator or by that part of the traffic indicator.

The animation sequence may comprise a plurality of traffic indicators, each traffic indicator representative of the traffic at a respective location. At least some of the traffic indicators may be contiguous.

The display device may comprise or be included in a user terminal. The display device may be included in a portable navigation device (PND). The processing resource may be included in a server and/or in the portable navigation device. The processing resource may be implemented partly in the server and partly in the portable navigation device. The display device may be remote from the server and may be included in the portable navigation device. The system may further comprise communication circuitry for transmitting at least one of the map data, the location data, the traffic data and the output between the server and the portable navigation device.

In a further, independent aspect of the invention there is provided a navigation or mapping apparatus comprising:—a location determining unit that is for installation in a vehicle and for determining the location of the vehicle; a display device; and a processing resource arranged to process map data, traffic data and the location data to produce an output representative of a traffic animation sequence, wherein the traffic animation sequence comprises a traffic indicator and a vehicle indicator on a map, the traffic indicator is representative of traffic, the vehicle indicator is representative of the location of the vehicle, the traffic indicator varies to represent the variation of traffic between a start time and an end time, the position of the vehicle indicator varies to represent the variation in location of the vehicle between the start time and the end time, and the display device is responsive to the output from the processing resource to display the traffic animation sequence.

In another, independent aspect of the invention there is provided a method of mapping traffic, comprising:—displaying a traffic indicator and a vehicle indicator on a map, the traffic indicator being representative of traffic and the vehicle indicator being representative of the location of a vehicle; and varying the traffic indicator and the position of the vehicle indicator in a traffic animation sequence to represent the variation between a start time and an end time of traffic and the location of the vehicle.

The method may further comprise receiving user input and selecting at least one of the start time, the end time, the or a view that is displayed, or the speed of the animation sequence in dependence on the user input.

In another, independent aspect of the invention there is provided a computer program product comprising computer readable instructions executable to put into effect a method as claimed or described herein.

In a further aspect of the invention a traffic information overlay is provided that changes according to the time, for example in an animation. The animation may be such as to not stop at the current situation, but may instead continue some time into the future. If the animation switches over from history to prediction, the background colour may be changed. A time bar may be used to represent the time. The user may be able to indicate on the time bar the start point of the animation. If prediction is supported, the user can indicate the stop time. Selecting one point on the animation may start the animation at that point in time. The animation may also be used to indicate where the animation currently is. A control item may be used to select the speed of the animation. The control item may be, for example, a second dimension of the time bar and, for example, left-right position may represent time and up-down position may represent speed (so, for example, selecting the upper half of the time bar may select a fast animation, selecting the lower half of the time bar may represent a slow animation). The user may be able to manually control the animation by manipulating a slider on the time bar (for example moving the slider forwards or backwards).

Any feature in one aspect of the invention may be applied to other aspects of the invention, in any appropriate combination. In particular, apparatus features may be applied to method features and vice versa.

### BRIEF DESCRIPTION OF THE DRAWINGS

At least one embodiment of the invention will now be described, by way of example only, with reference to the accompanying drawings, in which:

FIG. 1 is a schematic illustration of a Global Positioning System (GPS) usable by a navigation device;

FIG. 2 is a schematic illustration of electronic components of a navigation device;

FIG. 3 is a schematic diagram of a communications system including a wireless communication channel for communication with the navigation device;

FIGS. 4a and 4b are illustrative perspective views of a navigation device;

FIG. 5a is a schematic representation of an architectural stack of the navigation device of FIG. 2;

FIG. 5b is a schematic representation of an architectural stack of the server of FIG. 3;

FIG. 6 is a an illustrative screenshot from the navigation device of FIG. 2;

FIG. 7 is a schematic illustration of a traffic mapping or navigation system;

FIG. 8 is a flowchart illustrating in overview a map display process;

FIGS. 9a to 9d are views on a display that provide a schematic illustration of a traffic animation sequence;

FIGS. 10a to 10d are views on a display that provide a schematic illustration of a further traffic animation sequence; and

FIGS. 11a to 11d views on a display that provide schematic illustration of another traffic animation sequence.

### DETAILED DESCRIPTION OF EMBODIMENTS

Embodiments of the present invention will now be described with particular reference to a PND. It should be remembered, however, that the teachings of the present invention are not limited to PNDs but are instead universally applicable to any type of processing device that is configured to execute navigation software so as to provide route planning and navigation functionality. It follows therefore that in the context of the present application, a navigation device is intended to include (without limitation) any type of route planning and navigation device, irrespective of whether that device is embodied as a PND, a navigation device built into a vehicle, or indeed a computing resource (such as a desktop or portable personal computer (PC), mobile telephone or portable digital assistant (PDA)) executing route planning, navigation and/or mapping software.

It will also be apparent from the following that the teachings of the present invention even have utility in circumstances where a user is not seeking instructions on how to navigate from one point to another, but merely wishes to be provided with a view of a given location. In such circumstances the “destination” location selected by the user need not have a corresponding start location from which the user wishes to start navigating, and as a consequence references herein to the “destination” location or indeed to a “destination” view should not be interpreted to mean that the generation of a route is essential, that travelling to the “destination” must occur, or indeed that the presence of a destination requires the designation of a corresponding start location.

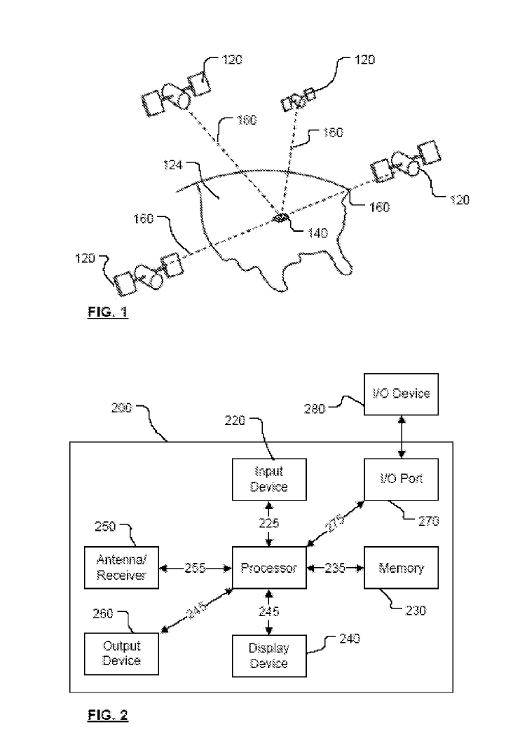

With the above provisos in mind, FIG. 1 illustrates an example view of Global Positioning System (GPS), usable by navigation devices. Such systems are known and are used for a variety of purposes. In general, GPS is a satellite-radio based navigation system capable of determining continuous position, velocity, time, and in some instances direction information for an unlimited number of users. Formerly known as NAVSTAR, the GPS incorporates a plurality of satellites which orbit the earth in extremely precise orbits. Based on these precise orbits, GPS satellites can relay their location to any number of receiving units.

The GPS system is implemented when a device, specially equipped to receive GPS data, begins scanning radio frequencies for GPS satellite signals. Upon receiving a radio signal from a GPS satellite, the device determines the precise location of that satellite via one of a plurality of different conventional methods. The device will continue scanning, in most instances, for signals until it has acquired at least three different satellite signals (noting that position is not normally, but can be determined, with only two signals using other triangulation techniques). Implementing geometric triangulation, the receiver utilizes the three known positions to determine its own two-dimensional position relative to the satellites. This can be done in a known manner. Additionally, acquiring a fourth satellite signal will allow the receiving device to calculate its three dimensional position by the same geometrical calculation in a known manner. The position and velocity data can be updated in real time on a continuous basis by an unlimited number of users.

As shown in FIG. 1, the GPS system is denoted generally by reference numeral 100. A plurality of satellites 120 are in orbit about the earth 124. The orbit of each satellite 120 is not necessarily synchronous with the orbits of other satellites 120 and, in fact, is likely asynchronous. A GPS receiver 140 is shown receiving spread spectrum GPS satellite signals 160 from the various satellites 120.

The spread spectrum signals 160, continuously transmitted from each satellite 120, utilize a highly accurate frequency standard accomplished with an extremely accurate atomic clock. Each satellite 120, as part of its data signal transmission 160, transmits a data stream indicative of that particular satellite 120. It is appreciated by those skilled in the relevant art that the GPS receiver device 140 generally acquires spread spectrum GPS satellite signals 160 from at least three satellites 120 for the GPS receiver device 140 to calculate its two-dimensional position by triangulation. Acquisition of an additional signal, resulting in signals 160 from a total of four satellites 120, permits the GPS receiver device 140 to calculate its three-dimensional position in a known manner.

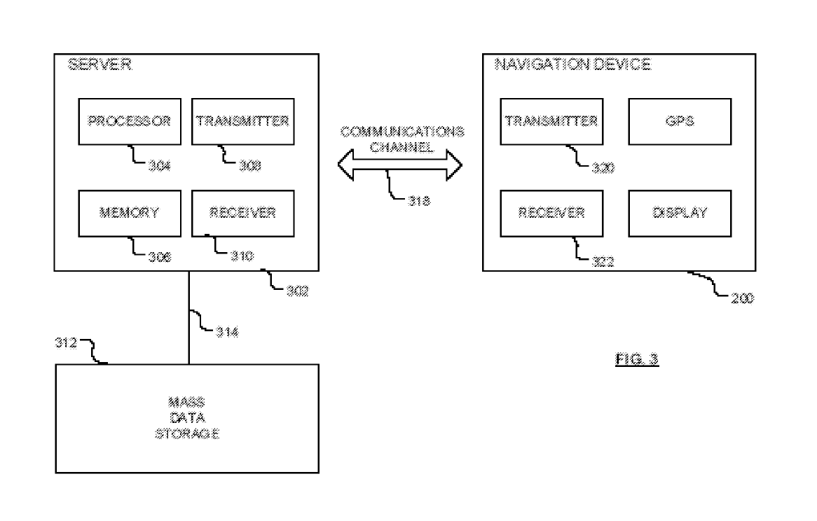

FIG. 2 is an illustrative representation of electronic components of a navigation device 200 according to one embodiment of the present invention, in block component format. It should be noted that the block diagram of the navigation device 200 is not inclusive of all components of the navigation device, but is only representative of many example components.

The navigation device 200 is located within a housing (not shown). The housing includes a processor 210 connected to an input device 220 and a display screen 240. The input device 220 can include a keyboard device, voice input device, touch panel and/or any other known input device utilised to input information; and the display screen 240 can include any type of display screen such as an LCD display, for example. In one arrangement the input device 220 and display screen 240 are integrated into an integrated input and display device, including a touchpad or touchscreen input so that a user need only touch a portion of the display screen 240 to select one of a plurality of display choices or to activate one of a plurality of virtual buttons.

The navigation device may include an output device 260, for example an audible output device (e.g. a loudspeaker). As output device 260 can produce audible information for a user of the navigation device 200, it is should equally be understood that input device 240 can include a microphone and software for receiving input voice commands as well.

In the navigation device 200, processor 210 is operatively connected to and set to receive input information from input device 220 via a connection 225, and operatively connected to at least one of display screen 240 and output device 260, via output connections 245, to output information thereto. Further, the processor 210 is operably coupled to a memory resource 230 via connection 235 and is further adapted to receive/send information from/to input/output (I/O) ports 270 via connection 275, wherein the I/O port 270 is connectible to an I/O device 280 external to the navigation device 200. The memory resource 230 comprises, for example, a volatile memory, such as a Random Access Memory (RAM) and a non-volatile memory, for example a digital memory, such as a flash memory. The external I/O device 280 may include, but is not limited to an external listening device such as an earpiece for example. The connection to I/O device 280 can further be a wired or wireless connection to any other external device such as a car stereo unit for hands-free operation and/or for voice activated operation for example, for connection to an ear piece or head phones, and/or for connection to a mobile phone for example, wherein the mobile phone connection may be used to establish a data connection between the navigation device 200 and the internet or any other network for example, and/or to establish a connection to a server via the internet or some other network for example.

FIG. 2 further illustrates an operative connection between the processor 210 and an antenna/receiver 250 via connection 255, wherein the antenna/receiver 250 can be a GPS antenna/receiver for example. It will be understood that the antenna and receiver designated by reference numeral 250 are combined schematically for illustration, but that the antenna and receiver may be separately located components, and that the antenna may be a GPS patch antenna or helical antenna for example.

Further, it will be understood by one of ordinary skill in the art that the electronic components shown in FIG. 2 are powered by power sources (not shown) in a conventional manner. As will be understood by one of ordinary skill in the art, different configurations of the components shown in FIG. 2 are considered to be within the scope of the present application. For example, the components shown in FIG. 2 may be in communication with one another via wired and/or wireless connections and the like. Thus, the scope of the navigation device 200 of the present application includes a portable or handheld navigation device 200.

In addition, the portable or handheld navigation device 200 of FIG. 2 can be connected or “docked” in a known manner to a vehicle such as a bicycle, a motorbike, a car or a boat for example. Such a navigation device 200 is then removable from the docked location for portable or handheld navigation use.

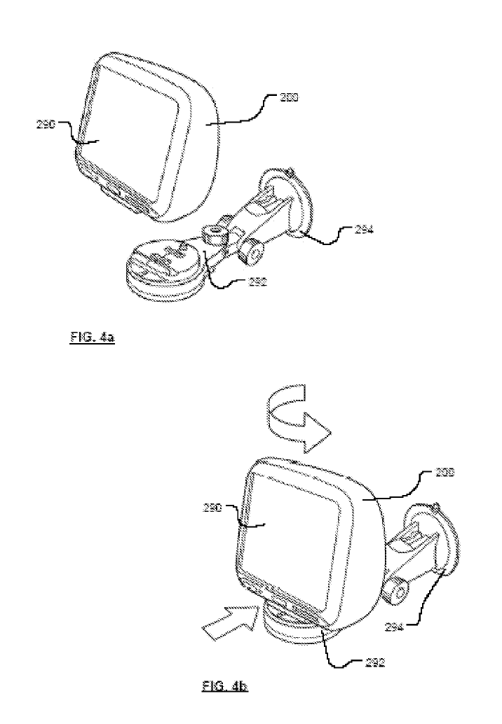

Referring now to FIG. 3, the navigation device 200 may establish a “mobile” or telecommunications network connection with a server 302 via a mobile device (not shown) (such as a mobile phone, PDA, and/or any device with mobile phone technology) establishing a digital connection (such as a digital connection via known Bluetooth technology for example). Thereafter, through its network service provider, the mobile device can establish a network connection (through the internet for example) with a server 302. As such, a “mobile” network connection is established between the navigation device 200 (which can be, and often times is mobile as it travels alone and/or in a vehicle) and the server 302 to provide a “real-time” or at least very “up to date” gateway for information.

The establishing of the network connection between the mobile device (via a service provider) and another device such as the server 302, using an internet (such as the World Wide Web) for example, can be done in a known manner. This can include use of TCP/IP layered protocol for example. The mobile device can utilize any number of communication standards such as CDMA, GSM, WAN, etc.

As such, an internet connection may be utilised which is achieved via data connection, via a mobile phone or mobile phone technology within the navigation device 200 for example. For this connection, an internet connection between the server 302 and the navigation device 200 is established. This can be done, for example, through a mobile phone or other mobile device and a GPRS (General Packet Radio Service)-connection (GPRS connection is a high-speed data connection for mobile devices provided by telecom operators; GPRS is a method to connect to the internet).

The navigation device 200 can further complete a data connection with the mobile device, and eventually with the internet and server 302, via existing Bluetooth technology for example, in a known manner, wherein the data protocol can utilize any number of standards, such as the GSRM, the Data Protocol Standard for the GSM standard, for example.

The navigation device 200 may include its own mobile phone technology within the navigation device 200 itself (including an antenna for example, or optionally using the internal antenna of the navigation device 200). The mobile phone technology within the navigation device 200 can include internal components as specified above, and/or can include an insertable card (e.g. Subscriber Identity Module or SIM card), complete with necessary mobile phone technology and/or an antenna for example. As such, mobile phone technology within the navigation device 200 can similarly establish a network connection between the navigation device 200 and the server 302, via the internet for example, in a manner similar to that of any mobile device.

For GPRS phone settings, a Bluetooth enabled navigation device may be used to correctly work with the ever changing spectrum of mobile phone models, manufacturers, etc., model/manufacturer specific settings may be stored on the navigation device 200 for example. The data stored for this information can be updated.

In FIG. 3 the navigation device 200 is depicted as being in communication with the server 302 via a generic communications channel 318 that can be implemented by any of a number of different arrangements. The server 302 and a navigation device 200 can communicate when a connection via communications channel 318 is established between the server 302 and the navigation device 200 (noting that such a connection can be a data connection via mobile device, a direct connection via personal computer via the internet, etc.).

The server 302 includes, in addition to other components which may not be illustrated, a processor 304 operatively connected to a memory 306 and further operatively connected, via a wired or wireless connection 314, to a mass data storage device 312. The processor 304 is further operatively connected to transmitter 308 and receiver 310, to transmit and send information to and from navigation device 200 via communications channel 318. The signals sent and received may include data, communication, and/or other propagated signals. The transmitter 308 and receiver 310 may be selected or designed according to the communications requirement and communication technology used in the communication design for the navigation system 200. Further, it should be noted that the functions of transmitter 308 and receiver 310 may be combined into a signal transceiver.

Server 302 is further connected to (or includes) a mass storage device 312, noting that the mass storage device 312 may be coupled to the server 302 via communication link 314. The mass storage device 312 contains a store of navigation data and map information, and can again be a separate device from the server 302 or can be incorporated into the server 302.

The navigation device 200 is adapted to communicate with the server 302 through communications channel 318, and includes processor, memory, etc. as previously described with regard to FIG. 2, as well as transmitter 320 and receiver 322 to send and receive signals and/or data through the communications channel 318, noting that these devices can further be used to communicate with devices other than server 302. Further, the transmitter 320 and receiver 322 are selected or designed according to communication requirements and communication technology used in the communication design for the navigation device 200 and the functions of the transmitter 320 and receiver 322 may be combined into a single transceiver.

Software stored in server memory 306 provides instructions for the processor 304 and allows the server 302 to provide services to the navigation device 200. One service provided by the server 302 involves processing requests from the navigation device 200 and transmitting navigation data from the mass data storage 312 to the navigation device 200. Another service provided by the server 302 includes processing the navigation data using various algorithms for a desired application and sending the results of these calculations to the navigation device 200.

The communication channel 318 generically represents the propagating medium or path that connects the navigation device 200 and the server 302. Both the server 302 and navigation device 200 include a transmitter for transmitting data through the communication channel and a receiver for receiving data that has been transmitted through the communication channel.

The communication channel 318 is not limited to a particular communication technology. Additionally, the communication channel 318 is not limited to a single communication technology; that is, the channel 318 may include several communication links that use a variety of technology. For example, the communication channel 318 can be adapted to provide a path for electrical, optical, and/or electromagnetic communications, etc. As such, the communication channel 318 includes, but is not limited to, one or a combination of the following: electric circuits, electrical conductors such as wires and coaxial cables, fibre optic cables, converters, radio-frequency (RF) waves, the atmosphere, empty space, etc. Furthermore, the communication channel 318 can include intermediate devices such as routers, repeaters, buffers, transmitters, and receivers, for example.

In one illustrative arrangement, the communication channel 318 includes telephone and computer networks. Furthermore, the communication channel 318 may be capable of accommodating wireless communication such as radio frequency, microwave frequency, infrared communication, etc. Additionally, the communication channel 318 can accommodate satellite communication.

The communication signals transmitted through the communication channel 318 include, but are not limited to, signals as may be required or desired for given communication technology. For example, the signals may be adapted to be used in cellular communication technology such as Time Division Multiple Access (TDMA), Frequency Division Multiple Access (FDMA), Code Division Multiple Access (CDMA), Global System for Mobile Communications (GSM), etc. Both digital and analogue signals can be transmitted through the communication channel 318. These signals may be modulated, encrypted and/or compressed signals as may be desirable for the communication technology.

The server 302 includes a remote server accessible by the navigation device 200 via a wireless channel. The server 302 may include a network server located on a local area network (LAN), wide area network (WAN), virtual private network (VPN), etc.

The server 302 may include a personal computer such as a desktop or laptop computer, and the communication channel 318 may be a cable connected between the personal computer and the navigation device 200. Alternatively, a personal computer may be connected between the navigation device 200 and the server 302 to establish an internet connection between the server 302 and the navigation device 200. Alternatively, a mobile telephone or other handheld device may establish a wireless connection to the internet, for connecting the navigation device 200 to the server 302 via the internet.

The navigation device 200 may be provided with information from the server 302 via information downloads which may be periodically updated automatically or upon a user connecting navigation device 200 to the server 302 and/or may be more dynamic upon a more constant or frequent connection being made between the server 302 and navigation device 200 via a wireless mobile connection device and TCP/IP connection for example. For many dynamic calculations, the processor 304 in the server 302 may be used to handle the bulk of the processing needs, however, processor 210 of navigation device 200 can also handle much processing and calculation, oftentimes independent of a connection to a server 302.

As indicated above in FIG. 2, a navigation device 200 includes a processor 210, an input device 220, and a display screen 240. The input device 220 and display screen 240 are integrated into an integrated input and display device to enable both input of information (via direct input, menu selection, etc.) and display of information through a touch panel screen, for example. Such a screen may be a touch input LCD screen, for example, as is well known to those of ordinary skill in the art. Further, the navigation device 200 can also include any additional input device 220 and/or any additional output device 241, such as audio input/output devices for example.

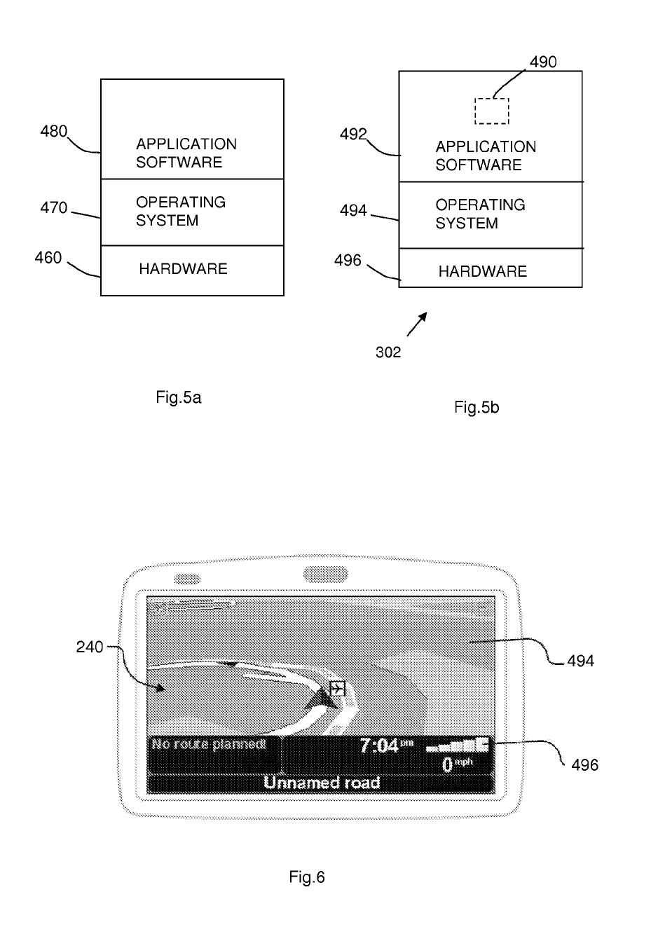

FIGS. 4A and 4B are perspective views of a navigation device 200. As shown in FIG. 4A, the navigation device 200 may be a unit that includes an integrated input and display device 290 (a touch panel screen for example) and the other components of FIG. 2 (including but not limited to internal GPS receiver 250, microprocessor 210, a power supply, memory systems 230, etc.).

The navigation device 200 may sit on an arm 292, which itself may be secured to a vehicle dashboard/window/etc. using a suction cup 294. This arm 292 is one example of a docking station to which the navigation device 200 can be docked.

As shown in FIG. 4B, the navigation device 200 can be docked or otherwise connected to an arm 292 of the docking station by snap connecting the navigation device 292 to the arm 292 for example. The navigation device 200 may then be rotatable on the arm 292, as shown by the arrow of FIG. 4B. To release the connection between the navigation device 200 and the docking station, a button on the navigation device 200 may be pressed, for example. Other equally suitable arrangements for coupling and decoupling the navigation device to a docking station are well known to persons of ordinary skill in the art.

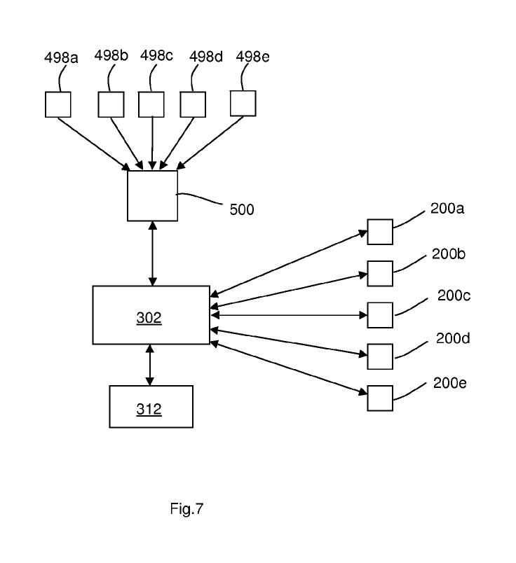

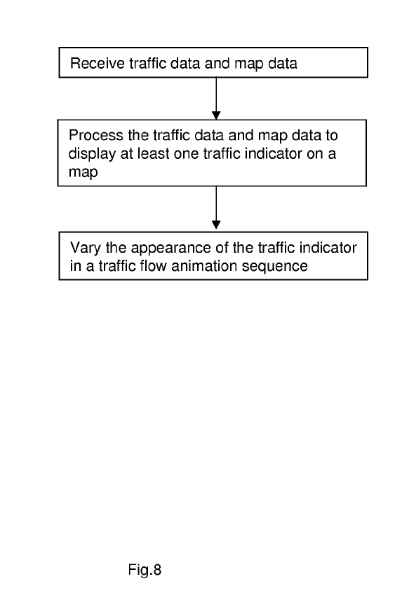

Referring now to FIG. 5a of the accompanying drawings, the memory resource 230 stores a boot loader program (not shown) that is executed by the processor 210 in order to load an operating system 470 from the memory resource 230 for execution by functional hardware components 460, which provides an environment in which application software 480 can run. The operating system 470 serves to control the functional hardware components 460 and resides between the application software 480 and the functional hardware components 460. The application software 480 provides an operational environment including the GUI that supports core functions of the navigation device 200, for example map viewing, route planning, navigation functions and any other functions associated therewith. The application software includes a traffic mapping module 490.

The server processor 304 also includes an application software layer 492, a hardware layer 494 and an operating system layer 494, as shown in FIG. 5b. The application software also includes a traffic mapping module 497.

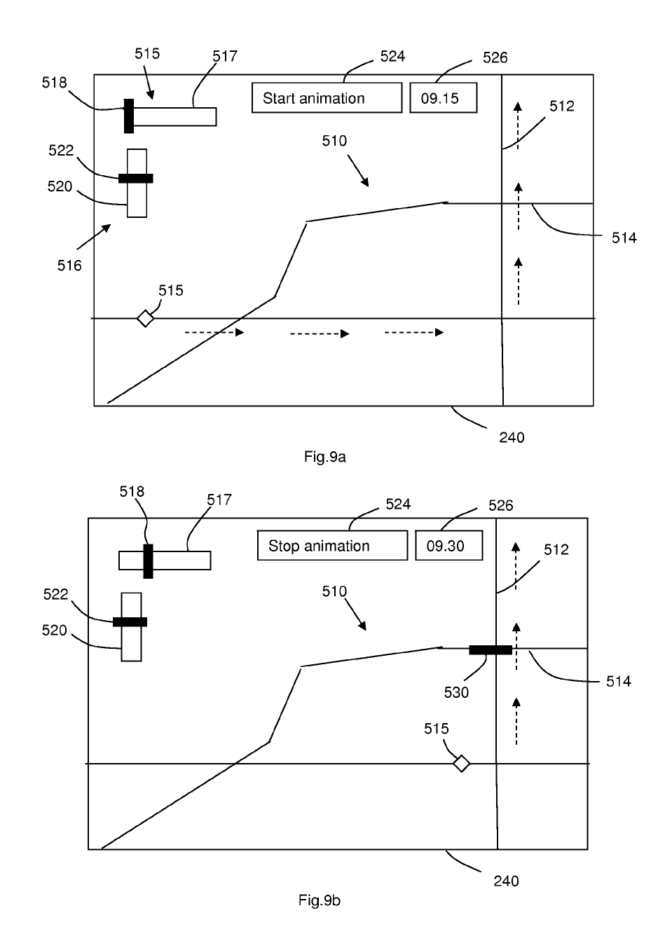

When the user switches on the device 200, the device 200 acquires a GPS fix and calculates (in a known manner) the current location of the device 200. The location is calculated using a location determining unit comprising the antenna/receiver 250, the connection 255 and a position determining module (not shown) included in the processor 210. The user is then presented, as shown in FIG. 6, with a view in pseudo three dimensions on a touch screen display 240 of the local environment 502 in which the navigation device 200 is determined to be located, and in a region 504 of the display 240 below the local environment a series of control and status messages. The device 200 provides route planning, mapping and navigation functions to the user, in dependence on user input provided by a series of interlinked soft or virtual buttons and menu screens that can be displayed on the display 240.

The user is able to select a destination using the buttons and menu screens, and the device 200 calculates a route to the destination. Once the user commences their journey the device 200 updates the map in accordance with determined changes in the location of the device 200 and, if a destination or route has been selected, provides the user with visual and, optionally, audible navigation instructions.

As mentioned above, the server 302 is able to provide services to the navigation device 200, including processing and transmitting map or other navigation data to the device 200. The server 302 is also able to provide map or other navigation data to other devices. In one mode of operation, the server 302 acts as a web server and generates web pages via which the mapping or other navigation data can be accessed by users.

One important feature of the embodiment of FIGS. 1 to 5, is that the server 302 and/or the navigation device 200 is able to provide traffic flow mapping, under control of the traffic mapping module 490 and/or the traffic mapping module 497 shown in FIGS. 5a and 5b.

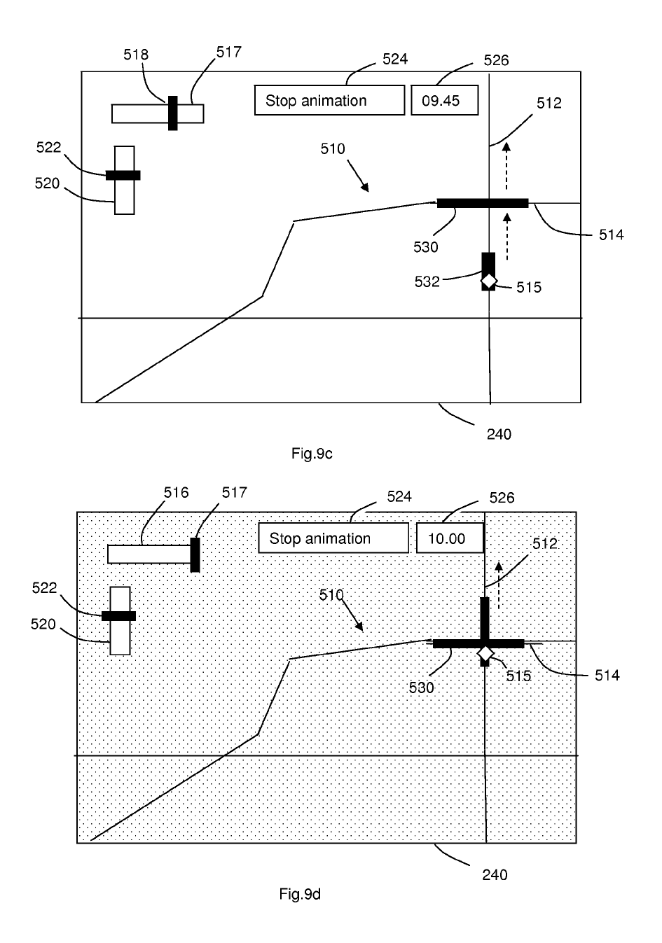

The server 302 is operably connected to receive map and traffic data, as illustrated in overview in FIG. 7, in which map and traffic data flows are indicated by arrows, and to pass the data to the traffic mapping module 497. Map data is received from the mass data storage 312, and historic or current traffic data obtained from a plurality of navigation devices 200a-200e or traffic flow measurement devices 498a-498e (for example traffic cameras or sensors) either directly or via a traffic control centre 500. The traffic data may be fed directly to the traffic mapping module 490 or may firstly be processed and stored in the mass data storage 312.

The traffic mapping module 497 is operable to process the map data and the traffic data to provide an output in the form of a display signal or signals that represent traffic graphically on a traffic map. The output can be time varying, and may be in any suitable display data format. The traffic mapping module 497 is also operable to display the traffic map on a web page, and/or to provide the output to the navigation device 200 for display of the traffic map on the display 240. The traffic map usually comprises at least one traffic indicator, the or each traffic indicator representative of traffic at a location, and the traffic mapping module 497 at least one traffic flow indicator in a traffic animation sequence to represent the variation of traffic over time.

In one embodiment the output from the traffic mapping module 497 is transmitted to the navigation device 200 and is subject to further processing by the traffic mapping module 490 included in the navigation device 200. The traffic mapping module 490 receives location data from the memory 230. The location data is representative of the location of the navigation device at different times, as determined by the location determining unit. The traffic mapping module 490 processes the output received from the traffic mapping module 497 to vary the appearance of at least one feature of the animation sequence in dependence upon the variation of the location of the vehicle. Thus, the traffic mapping module 490 and the traffic mapping module 497 co-operate to produce the animation sequence.

In another embodiment, the traffic data and/or the map data is transmitted from the server 302 to the navigation device 200, and the animation sequence is produced by the traffic mapping module 490 alone. In an alternative embodiment, the location data is transmitted from the navigation device 200 to the server 302, and the animation sequence is produced by the traffic mapping module 497 alone.

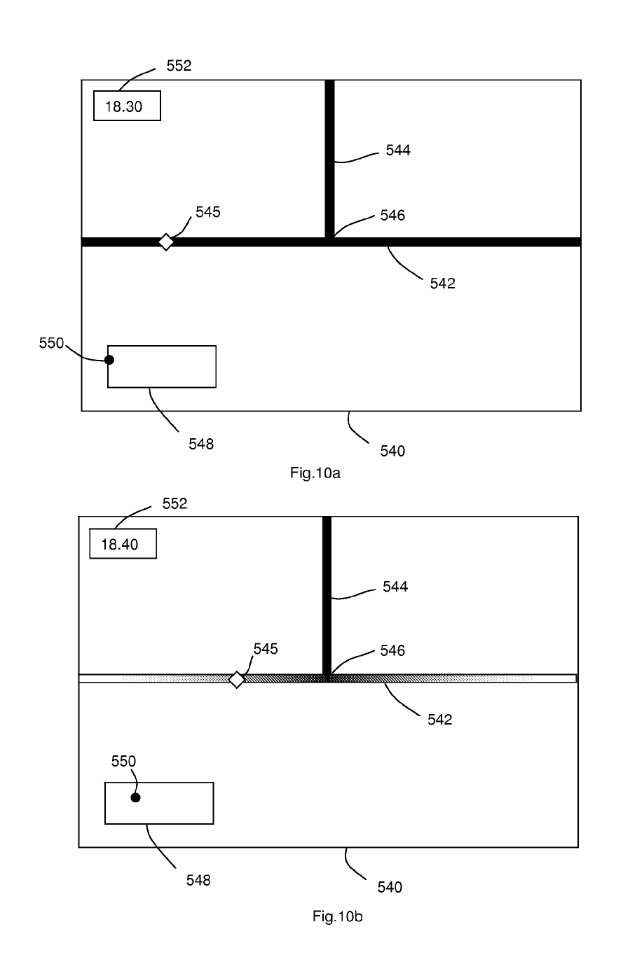

Operation of the traffic mapping modules 490, 497 is illustrated in overview in the flowchart of FIG. 8. The traffic mapping modules 490, 497 provides a view of traffic that is not static, but instead includes a traffic information overlay that changes to represent changes in traffic over time. For example, the traffic situation over the last hour can be represented in an animation of 10 seconds. It has been found that an animated visual representation can be interpreted by humans more easily than a static view, and helps humans to make predictions of future conditions based on past conditions.

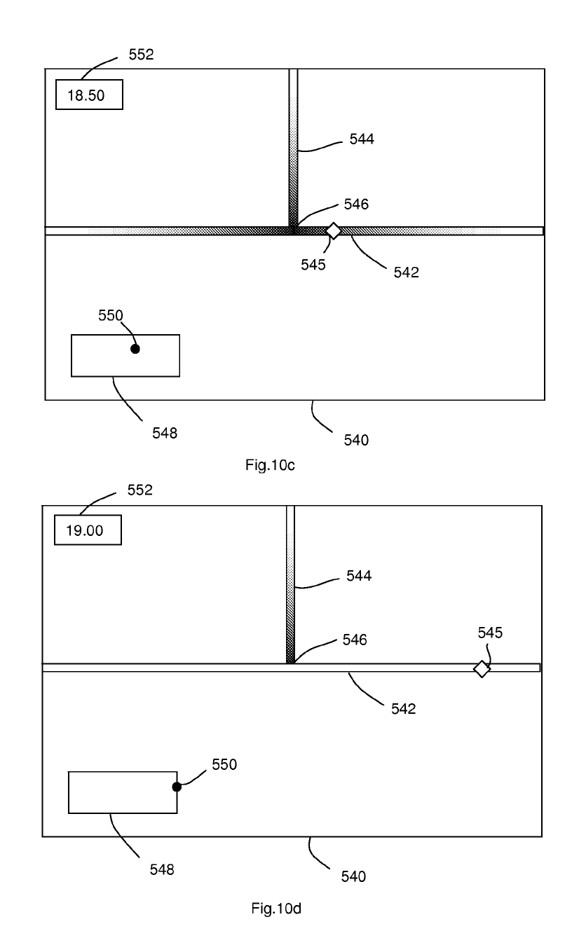

An example of a traffic animation sequence is illustrated in FIGS. 9a to 9d. The traffic animation sequence is generated at the current time of 9.50 am, and FIGS. 9a to 9d are representative of traffic at times 9.15 am, 9.30 am, 9.45 am and 10.00 am respectively. The traffic animation sequence of FIGS. 9a to 9d shows the development of traffic queues between the start time of 9.15 am and the end time of 10 am for a selected area of a city.

In the example of FIG. 9a, traffic data is transmitted from the server 302 to the navigation device 200 installed in a vehicle, and is stored in the memory 230 with map data and location data that represents the location of the vehicle over time. The traffic mapping module 490 processes the traffic data, the map data and the location data to product an output display signal that is sent to and processed by the display 240 to cause the display of the map on the display 240. The display signal could also be sent to and displayed on any other suitable display device, or displayed on a web page.

As shown in FIG. 9a, a map comprising a network of roads 510 in the selected area of the city is displayed on the display 240. The network of roads includes a road 512 and a road 514 that meet at a junction. A vehicle indicator 515 is displayed, indicating the location of the vehicle at 9.15 am. Dashed arrows indicate a predetermined route that is being followed by the vehicle. A time indicator, in the form of a time bar 515, and a speed indicator, in the form of a speed bar 516, are also displayed. The time indicator comprises a time indicator area 517 and a moveable time marker 518, and the speed indicator comprises an animation speed indicator area and a moveable speed marker 522. A start/stop animation button 524 and a time box 526 indicating the time for which the traffic is represented, are also displayed.

No traffic indicator is displayed in FIG. 9a, indicating that there were no traffic queues in the selected area at 9 am. Upon operation of the start/stop button 524 by the user the animation sequence starts.

At a time of 2 seconds after the start of the animation sequence, the view shown in FIG. 9a changes to the view shown in FIG. 9b, which represents the traffic at 9.30 am. It can be seen that a traffic indicator 530 has now been overlaid on the map along road 514 around the junction between the roads 512, 514. In this example, the traffic indicator 530 is representative of a traffic queue. The traffic indicator 530 overlays those areas on the map that represent a location where a traffic queue is present. Thus, the length and location of the traffic indicator 530 in this example is representative of the length and location of a traffic queue.

It can be seen, by comparing FIGS. 9a and 9b, that the time marker 518 has moved relative to the time indicator area 517, indicating that the view of FIG. 9b represents traffic at a later time than the view of FIG. 9a. The vehicle indicator has also moved on the map, representing the movement of the vehicle between 9.15 am and 9.30 am.

After a further display time of 2 seconds, the view shown in FIG. 9b changes to the view shown in FIG. 9c, which represents the traffic at 9.45 am. It can be seen that the traffic indicator 530 has extended in both directions along road 514 indicating that the traffic queue has grown. A further traffic indicator 532 is also present on road 512, indicating the presence of a further traffic queue, and the vehicle indicator 515 is overlaid on the traffic indicator 532 indicating that the vehicle was in the traffic queue at 9.45 am. The time marker 518 has moved further relative to the time indicator area 517, indicating that the view of FIG. 9c represents traffic at a later time than the views of FIGS. 9a and 9b.

After a further display time of 2 seconds, the view shown in FIG. 9c changes to the view shown in FIG. 9d, which represents the predicted traffic at 10 am. The background colour of the map changes (as indicated by dots) in FIG. 9d, compared to the background colour of FIGS. 9a to 9c, to indicate that the view of FIG. 9d represents predicted traffic at a future time, rather than traffic at a current or past time. It can be seen that the traffic indicator 530 has extended along road 512 around the junction between roads 512, 514 indicating a predicted growth in the traffic queue. It is also predicted that the vehicle will be in the traffic queue, as indicated by the overlay of the vehicle indicator 515 on the traffic indicator 530. The further traffic indicator 532 has disappeared, indicating that the further traffic queue along road 512 is predicted to disappear. The user may decide to request an alternative route from the navigation device 200 upon seeing that they are predicted to be in a traffic queue, or subject to significant delay. Alternatively, the navigation device may automatically suggest an alternative route.

In a variant of the embodiment of FIG. 9, a plurality of vehicle indicators are displayed, each representing the location of a different vehicle. The user may select which vehicles are to be represented by the vehicle indicators. Location data for each vehicle is transmitted from a location determining unit associated with each vehicle to the server 302 for storage, processing and/or onward transmission.

In a further variant of the embodiment of FIG. 9, the location data represents predicted or other potential locations of one or more vehicles, rather than measured locations. For example, the location data can represent the predicted locations of a vehicle along a selected route given a selected departure time.

If the user does not operate the start/stop animation button 524, then after a further display time of 2 seconds, the view shown in FIG. 9d will be replaced by the view shown in FIG. 9a and the animation sequence will start again and will loop between the views shown in FIGS. 9a to 9d.

The position of the moveable marker 522 relative to the speed indicator area 520 is unchanged between each of FIGS. 9a to 9d, indicating that the speed of the animation sequence is unchanged. If the display time for the display of the views of FIGS. 9a to 9d were to be increased (for example to 10 seconds) thus providing a lower speed for the animation sequence then the moveable marker 522 would move to a lower position relative to the speed indicator area 520. If the display time between the display of the views of FIGS. 9a to 9d were to be decreased (for example to 0.5 seconds) thus providing a higher speed for the animation sequence then the moveable marker 522 would move to a higher position relative to the speed indicator area 520.

The moveable markers 518 and 522 may be moved by the user in order to vary the time at which the traffic is represented and the speed of the animation sequences. The user may also set the start time and the end time.

The moveable marker 518 can function as a slider, and the user can slide the moveable marker 518 relative to the time indicator area 517 by pressing on the touch screen display 240 with their finger or a pointer at the position of the moveable marker 518 and then moving their finger or pointer whilst maintaining the pressure on the touch screen display 240. The view displayed on the display 240 varies in dependence on the position of the moveable marker. For example, if the moveable marker is moved to the left hand edge of the time indicator area 517 the view will change to that shown in FIG. 9a. The rate at which the moveable marker is used 518 determines the rate at which the view on the display 240 changes, and thus movement of the moveable marker 518 by the user can override the animation sequence speed represented by moveable marker 522.

When the user releases the moveable marker 518, the animation sequence resumes with the view corresponding to the position of the moveable marker 518 if the animation was playing at the time the user moved the moveable marker 518. Alternatively, if the animation was not playing at the time the user moved the moveable marker 518, the view corresponding to the position of the moveable marker is displayed until the user starts the animation by operation of the start/stop animation sequence button 524.

The moveable marker 522 can also function as a slider, and the user can slide the moveable marker 511 relative to the speed indicator area 520 in order to select the speed of the animation sequence (the display time for each successive view, each successive view representative of traffic at a step time later than the preceding view, in this example).

A point, click and move procedure using a mouse can also be used to slide or otherwise move the moveable markers 518, 522.

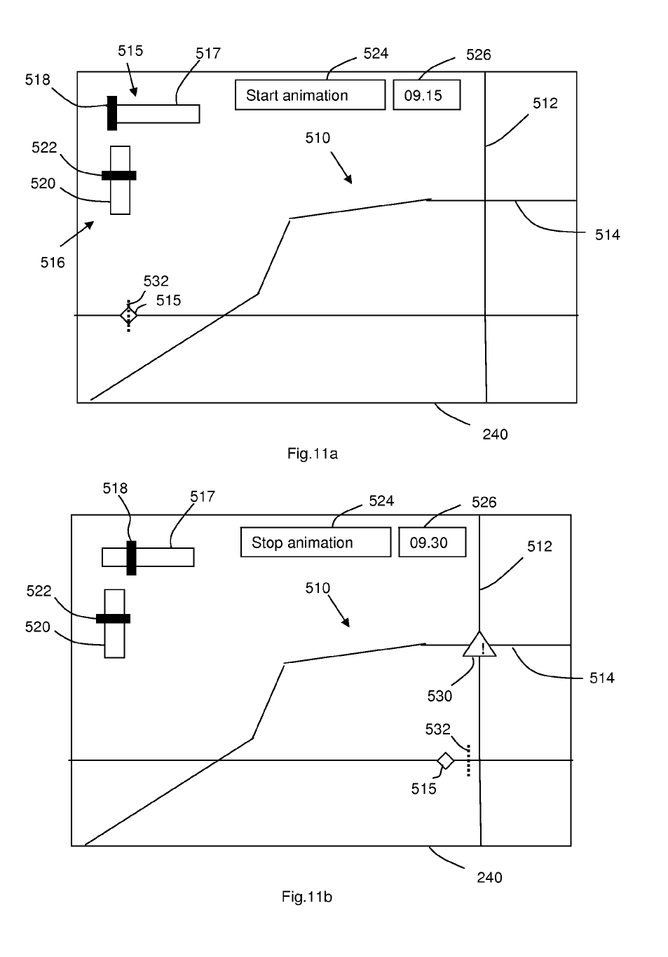

A further example of a traffic animation sequence is illustrated in FIGS. 10a to 10d. The traffic animation sequence is generated at the current time of 7.05 pm, and FIGS. 10a to 10d are representative of traffic at times 6.30 pm, 6.40 pm, 6.50 pm and 7 pm respectively. Each view in the animation sequence is displayed on web page 540 in this example.

As shown in FIG. 10a, a map representing roads 542, 544 that meet at a junction 546 is displayed on the web page 540. The map can be zoomed out or zoomed in further upon command of the user to display a smaller or larger area (up to an area covering an entire city or country if desired).

A combined time and animation sequence speed indicator comprising an indicator area 548 and a moveable marker 550, and a time box 552 indicating the time for which traffic is represented are also displayed.

The traffic indicator of FIG. 10 comprises the shading of the roads 542, 544. Complete shading (black) at a location indicates stationary traffic at that location, no shading (white) at a location indicates traffic flowing at or above the speed limit at that location, and the level of intermediate shading (greyscale) at a location indicates the average speed (greater than zero and less than the speed limit) of vehicles at that location. The vehicle location is indicated by a vehicle indicator 545.

As was the example of FIGS. 9a to 9d, once the animation sequence has started the view displayed on the display 540 is changed after a display time (5 seconds in this case) to display the next view in the animation sequence, each view in the animation sequence being represented by one of FIGS. 9a to 9d.

It can be seen from FIGS. 10a to 10d that at 6.30 pm the traffic was stationary along the entire displayed length of the roads 542, 544, and that at 6.40 pm the traffic was stationary on road 544 and around the region of the junction 546 on road 542 but that the traffic was moving increasingly more freely at locations on road 542 at increasing distances from the junction 546. At 6.50 pm, the flow of traffic along road 542 was substantially the same as it had been at 6.40 pm, the flow of traffic along road 544 was increasingly free away from the junction 546, but the traffic on road 544 near to the junction 546 was stationary. At 7 pm, the flow of traffic along road 544 was substantially the same as it had been at 6.50 pm, and traffic was flowing freely along the entire displayed length of road 542.

The combined time and animation sequence speed indicator indicates the time for which traffic is represented by the position of the moveable marker 550 relative to the indicator area 548 in a horizontal direction, and indicates the speed of the animation sequence by the position of the moveable marker 550 relative to the indicator area 548 in a vertical direction. In a similar way to that described in relation to the embodiment of FIGS. 9a to 9d, the moveable marker can be slid or otherwise moved by a user relative to the indicator area in order to vary the time and/or the speed of the animation sequence.

The traffic indicators in FIGS. 9 and 10 represent only traffic in a single direction for each road, for clarity. In variants of the embodiments of FIGS. 9 and 10, traffic indicators are provided for each direction, and may be displayed side by side. The traffic indicators can be colour coded or provided with arrows or text to indicate direction of traffic flow. For example, in the embodiment of FIG. 9, in which the traffic indicator represents the size and location of a traffic queue, text (for example “eastbound” or “westbound”) or an arrow or arrows can be associated with the traffic indicator to indicate the direction of traffic flow for which there is a queue.

The traffic indicators of FIGS. 9 and 10 are representative of traffic queue size or of average speed of vehicles. In alternative embodiments traffic indicators can represent any other aspect of traffic. For example, a traffic indicator can represent the rate of change of the size of a traffic queue or traffic speed, or vehicle throughput (for example number of vehicles passing per minute).

In the embodiments of FIGS. 9 and 10, the animation sequence comprises a series of static views displayed one after the other, for a display time. In alternative embodiments, the animation sequence is continuous or the display time between successive views is sufficiently short to give the impression to the user of being continuous. In such alternative embodiments, traffic flows for each successive view may be interpolated from measured traffic flows at earlier and later times.

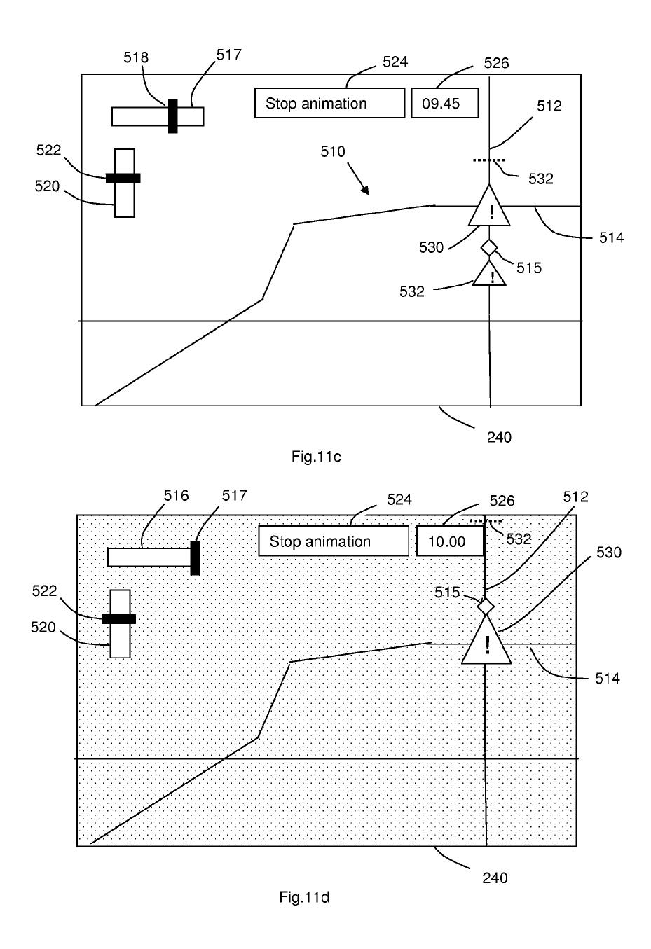

The traffic flow indicators may take any suitable form, and variation in traffic can be represented by, for example, variation in size, shape, colour, number or associated text or symbols of the traffic indicators. For example, FIGS. 11a to 11d illustrate a variant of the embodiment of FIGS. 9a to 9d, in which the traffic queues at the times and locations illustrated in FIGS. 9a to 9d are indicated by traffic indicators in the form of triangular icons 560 that vary in size to represent the variation in size of the traffic queues. The location of a vehicle at each time is indicated by a vehicle indicator 515. The expected location of the vehicle, if the vehicle has followed a predetermined route at an expected speed determined before starting the journey along the route is also indicated, by a further vehicle indicator 532. It can be seen that the actual (or predicted) location of the vehicle gradually falls behind the expected location of the vehicle determined before starting the journey along the route, as the vehicle encounters delays.

In the embodiments of FIGS. 9 to 11, the location of a vehicle is indicated by a vehicle indicator included in the animation sequence, and the position of the vehicle indicator varies to represent the variation in location of the vehicle. Alternatively or additionally, at least one other feature of the animation sequence is varied in dependence upon the variation in location of the vehicle. For example, the map can be centred on the display about the location of the vehicle. The area represented by the map can thus change as the vehicle's location changes. The orientation of the map can also change in dependence upon any change in orientation of the vehicle.

In the embodiments of FIGS. 9 to 11, traffic indicators are displayed to a user either via a website, or via a portable navigation device 200, but can also be displayed via any suitable user terminal or user device, for example a mobile phone.

In another embodiment, the traffic indicators are displayed to traffic managers in a traffic control centre, for example the traffic control centre 500, and used to analyse traffic. The traffic indicators may also be used for incident detection. The displayed features may be used to detect unexpected traffic features. Traffic indicators may be displayed if a traffic situation at a particular location and particular time is different to that expected at that location and time, which may be determined by comparison with a threshold for that location and time, for example. Parameters, such as thresholds, that determine the conditions under which traffic indicators are displayed, and the appearance of such traffic indicators, can be tuned in dependence on user preferences and/or in dependence on historical data.

It will be appreciated that whilst various aspects and embodiments of the present invention have heretofore been described, the scope of the present invention is not limited to the particular arrangements set out herein and instead extends to encompass all arrangements, and modifications and alterations thereto, which fall within the scope of the appended claims.

For example, although the present invention may be exemplified as a portable navigation device, it would be appreciated that route planning and navigation functionality may also be provided by a desktop or mobile computing resource running appropriate software. For example, the Royal Automobile Club (RAC) provides an on-line route planning and navigation facility at http://www.rac.co.uk, which facility allows a user to enter a start point and a destination whereupon the server with which the user's computing resource is communicating calculates a route (aspects of which may be user specified), generates a map, and generates a set of exhaustive navigation instructions for guiding the user from the selected start point to the selected destination.

Whilst embodiments described in the foregoing detailed description refer to GPS, it should be noted that the navigation device may utilise any kind of position sensing technology as an alternative to (or indeed in addition to) GPS. For example the navigation device may utilise using other global navigation satellite systems such as the European Galileo system. Equally, it is not limited to satellite based but could readily function using ground based beacons or any other kind of system that enables the device to determine its geographic location.

Alternative embodiments of the invention can be implemented as a computer program product for use with a computer system, the computer program product being, for example, a series of computer instructions stored on a tangible data recording medium, such as a diskette, CD-ROM, ROM, or fixed disk, or embodied in a computer data signal, the signal being transmitted over a tangible medium or a wireless medium, for example, microwave or infrared. The series of computer instructions can constitute all or part of the functionality described above, and can also be stored in any memory device, volatile or non-volatile, such as semiconductor, magnetic, optical or other memory device.

It will also be well understood by persons of ordinary skill in the art that whilst the embodiments described herein implement certain functionality by means of software, that functionality could equally be implemented solely in hardware (for example by means of one or more ASICs (application specific integrated circuit)) or indeed by a mix of hardware and software. As such, the scope of the present invention should not be interpreted as being limited only to being implemented in software.

It will be understood that the present invention has been described above purely by way of example, and modifications of detail can be made within the scope of the invention.

Each feature disclosed in the description, and (where appropriate) the claims and drawings may be provided independently or in any appropriate combination.

Lastly, it should also be noted that whilst the accompanying claims set out particular combinations of features described herein, the scope of the present invention is not limited to the particular combinations hereafter claimed, but instead extends to encompass any combination of features or embodiments herein disclosed irrespective of whether or not that particular combination has been specifically enumerated in the accompanying claims at this time.

1-20. (canceled)

21. A mobile phone comprising:
a display, an internal GPS receiver, a microprocessor, a power supply, a memory system, communication circuitry for receiving traffic data from a server, and a processing resource arranged to process map data and the traffic data;
the mobile phone operable to display a map and further operable to display a traffic information overlay that changes according to time, the traffic information overlay continuing from a current situation to some time into the future, including a series of views, wherein each view is a static view;
wherein a time difference between a first traffic determination time, for which the traffic is represented by a view in the series, and a second traffic determination time, for which the traffic is represented by a next view in the series, is substantially equal to a predetermined step time;
the traffic information overlay comprising a plurality of traffic indicators on the map comprising a network of roads, a traffic indicator being provided for each direction along a road;
wherein each traffic indicator is representative of traffic at a respective location, and is variable to represent the variation of traffic, the variation of the traffic indicator including varying the colour of the traffic indicator.

22. A mobile phone according to claim 21, wherein estimation of traffic flow at a location at a future time comprises extrapolating from at least one of: (i) current traffic flows at the location and for other locations; and (ii) historic traffic flows at the location and for other locations.

23. A mobile phone according to claim 21, wherein the variation of the traffic indicator further includes varying at least one of the position, size and shape or associated text of the traffic indicator.

24. A mobile phone according to claim 21, wherein the traffic indicator is representative of a traffic queue.

25. A mobile phone according to claim 24, wherein the variation of the traffic indicator is representative of at least one of: (i) a variation in the length of the traffic queue; and (ii) a variation in the rate of change of the length of the traffic queue.

26. A mobile phone according to claim 21, wherein the communication circuitry is further arranged to receive the map data from a server.

27. A computer program product operable to be installed on a mobile phone, the mobile phone comprising:
a display, an internal GPS receiver, a microprocessor, a power supply, a memory system, communication circuitry for receiving traffic data from a server, and a processing resource arranged to process map data and the traffic data;
the computer program product when running on the mobile phone operable to display a map and further operable to display a traffic information overlay that changes according to time, the traffic information overlay continuing from a current situation to some time into the future, including a series of views, wherein each view is a static view;
wherein a time difference between a first traffic determination time, for which the traffic is represented by a view in the series, and a second traffic determination time, for which the traffic is represented by a next view in the series, is substantially equal to a predetermined step time;
the traffic information overlay comprising a plurality of traffic indicators on the map comprising a network of roads, a traffic indicator being provided for each direction along a road;
wherein each traffic indicator is representative of traffic at a respective location, and is variable to represent the variation of traffic, the variation of the traffic indicator including varying the colour of the traffic indicator.

28. A computer program product according to claim 27, wherein estimation of traffic flow at a location at a future time comprises extrapolating from at least one of: (i) current traffic flows at the location and for other locations; and (ii) historic traffic flows at the location and for other locations.

29. A computer program product according to claim 27, wherein the variation of the traffic indicator further includes varying at least one of the position, size and shape or associated text of the traffic indicator.

30. A computer program product according to claim 27, wherein the traffic indicator is representative of a traffic queue.

31. A computer program product according to claim 30, wherein the variation of the traffic indicator is representative of at least one of: (i) a variation in the length of the traffic queue; and (ii) a variation in the rate of change of the length of the traffic queue.

32. A computer program product according to claim 27, wherein the communication circuitry is further arranged to receive the map data from a server.

33. Traffic mapping system comprising a mobile phone and a server, wherein the mobile phone comprises:
a display, an internal GPS receiver, a microprocessor, a power supply, a memory system, communication circuitry for receiving traffic data from the server, and a processing resource arranged to process map data and the traffic data;
the mobile phone operable to display a map and further operable to display a traffic information overlay that changes according to time, the traffic information overlay continuing from a current situation to some time into the future, including a series of views, wherein each view is a static view;
wherein a time difference between a first traffic determination time, for which the traffic is represented by a view in the series, and a second traffic determination time, for which the traffic is represented by a next view in the series, is substantially equal to a predetermined step time;
the traffic information overlay comprising a plurality of traffic indicators on the map comprising a network of roads, a traffic indicator being provided for each direction along a road;
wherein each traffic indicator is representative of traffic at a respective location, and is variable to represent the variation of traffic, the variation of the traffic indicator including varying the colour of the traffic indicator.

34. Traffic mapping system according to claim 33, wherein estimation at the server of traffic flow at a location at a future time comprises extrapolating from at least one of: (i) current traffic flows at the location and for other locations; and (ii) historic traffic flows at the location and for other locations.

35. Traffic mapping system according to claim 34, wherein the variation of the traffic indicator further includes varying at least one of the position, size and shape or associated text of the traffic indicator.

36. Traffic mapping system according to claim 34, wherein the traffic indicator is representative of a traffic queue.

37. Traffic mapping system according to claim 36, wherein the variation of the traffic indicator is representative of at least one of: (i) a variation in the length of the traffic queue; and (ii) a variation in the rate of change of the length of the traffic queue.

38. Traffic mapping system according to claim 36, wherein the communication circuitry is further arranged to receive the map data from a server.
